(19) United States
(12) Patent Application Publication
(10) Pub. No.: US 2026/0166500 A1
(43) Pub. Date: Jun. 18, 2026

(54) A GUIDING DEVICE FOR GUIDING AN IMPACT HEAD AND A HOMOGENIZING VALVE COMPRISING SAID GUIDING DEVICE

(71) Applicant: GEA MECHANICAL EQUIPMENT ITALIA S.P.A., PARMA (IT)

(72) Inventors: PIERLUIGI MAGNINI, PARMA (IT); CARLO NEGRI, PARMA (IT); FILIPPO FONTANESI, PARMA (IT); MASSIMILIANO BENASSI, FORNOVO di TARO (PARMA) (IT)

(21) Appl. No.: 18/710,532

(22) PCT Filed: Aug. 24, 2023
(86) PCT No.: PCT/IB2023/058407

§ 371 Date: May 15, 2024

(30) Foreign Application Priority Data
Nov. 16, 2022 (IT) 102022000023643

(51) Int. Cl. B01F 25/441; B01F 25/442

(52) U.S. Cl. CPC B01F 25/4412; B01F 25/4422

(57) ABSTRACT

A guiding device (1) for guiding an impact head (100) of a homogenizing valve (200), said guiding device (1) comprising:
a solid body (2) having a cylindrical symmetry and having an internal cavity (3) passing through the solid body (2), the internal cavity (3) developing according to an axis of symmetry (A-A) of the solid body (2), the solid body (2) having a plurality of passages (4) that are obtained for allowing the passage of a fluid;
a sleeve (9) fitted within the internal cavity (3) of the solid body (2) for receiving the impact head (100).

### TECHNICAL FIELD

The present invention relates to a guiding device for guiding an impact head and a homogenizing valve comprising said guiding device.

The invention proposed here is used in the food industry, in particular in the dairy sector, or in the chemical, pharmaceutical or cosmetic industry. The invention can also be used in manufacturing areas where homogenization is a step of the production process.

Consider, for example, the production of carbon-based nanostructured materials, such as graphene and carbon nanotubes or cellular breakdown of yeasts, algae, or microorganisms for the production of intracellular material.

### BACKGROUND ART

As it is well-known, apparatus for homogenising fluids crush the particles, reducing their dimensions to a minimum and make the dimensions of the particles uniform, thus reducing variation of distribution of the dimensions of the particles.

Said homogenising apparatus, also in the different embodiments so far known, comprise a high-pressure pump and a homogenising valve. The homogenising valve comprises a first chamber receiving the fluid at high pressure from the pump delivery and a second chamber capable of supplying outgoing homogenised fluid at low pressure. The homogenising action is obtained by forcing the fluid to pass through an interspace or gap with reduced dimensions afforded between the first and the second chamber. The gap is defined by a passage head integrally joined to the valve body and by an impact head axially mobile with respect to the passage head.

The fluid coming from the inlet presses on a surface of the impact head exerting on it a pressure which tends to widen the gap.

A pusher capable of contrasting the pressure of the fluid in an axial direction is applied to the impact head. The dimension of the gap is controlled by acting directly on the pusher as a function of the valve flow rate and pressure operating values.

As already indicated above, the fluid loses pressure by passing through the gap and is simultaneously accelerated, thus allowing fragmentation of the particles in suspension.

In order to optimise the energy used in the homogenisation process, over recent years, the Applicant has developed homogenising valves in which the first and the second chamber have an annular shape. Said solutions are described in European patent EP810025 and in Italian patent no. 1,385,953 in the name of the Applicant.

The annular configuration of the two chambers allows the fluid at high pressure to press on an annular surface of the impact head, thus allowing operation with a gap of reduced dimensions with the same energy applied. One limit of the solution just described lies in the form and position of the pusher acting on the impact head. The pusher consists in a shaft integrally fixed to the impact head and located in the upper part of the homogenizing valve.

Under the pushing action of the shaft, the impact head is moved downwards, that means towards the gap.

Actuating the impact head far from the working area, which is the gap, introduces tolerances that may result in an undesired mechanical misalignment. The higher is the misalignment, the worse is the performance of the homogenizing valve.

### Disclosure of the Invention

In this context, the object of the present invention is to provide a guiding device for guiding an impact head and a homogenizing valve, which overcome the problems of the prior art cited above.

In particular, the object of the present invention is to propose a guiding device for guiding an impact head in which the impact head may BE actuated in a more accurate and reliable way, avoiding or at least decreasing the risks of mechanical misalignments.

Another object of the present invention is to propose a guiding device for guiding an impact head wherein the useful lifetime of the impact head is increased over the prior art solutions.

The stated technical task and specified aims are substantially achieved by a guiding device for guiding an impact head of a homogenizing valve, the guiding device comprising:
a solid body having a cylindrical symmetry and having an internal cavity passing through the solid body, said internal cavity developing according to an axis of symmetry of the solid body, said solid body having a plurality of passages that are obtained for allowing the passage of a fluid;
a sleeve fitted within the internal cavity of the solid body for receiving the impact head.

According to an aspect of the invention, the solid body is made of a single piece.

According to an embodiment of the invention, the solid body comprises a case and a core that are integrally connected, the internal cavity being delimited by the core.

In particular, the passages of the plurality of passages are through-holes obtained between the case and the core.

The through-holes are separated by connecting elements that connect the core to the case.

Preferably, the core has a substantially hollow cylindrical shape.

More preferably, the core has an annular protrusion at one end so as to retain the sleeve.

In particular, the annular protrusion projects inward towards the internal cavity.

According to one aspect of the invention, the through-holes are arranged around the core.

In particular, each of said through-holes has an arcuated development.

According to another embodiment of the invention, the passages of said plurality of passages are grooves obtained in the solid body.

In particular, the solid body comprises a first element and a second element that are integrally connected and coaxial.

The second element originates from the first element.

Preferably, the grooves are obtained in the second element.

According to one aspect of the invention, the second element has a cylindrical symmetry.

The grooves are obtained on an external lateral surface of the second element.

In particular, the guiding device further comprises a stop element operatively active on the sleeve for maintaining it fitted within the internal cavity of the solid body. The second element has an internal annular groove for receiving the stop element.

Preferably, the stop element is a seeger.

The stated technical task and specified aims are substantially achieved by a homogenizing valve comprising:
a valve body defining a through-hole having axial development with respect to the valve body;
a shaft housed in said through-hole;
a passage head integrally connected to the valve body;
an impact head integrally connected to the shaft;
a gap defined by the passage head and the impact head;
a guiding device according to the claimed invention, said impact head being received by the sleeve of said guiding device.

Preferably, the impact head is made of one of the following materials: tungsten carbide, ceramic, boron nitride, silicon carbide, silicon nitride.

### BRIEF DESCRIPTION OF DRAWINGS

Further characteristics and advantages of the present invention will more fully emerge from the non-limiting description of a preferred but not exclusive embodiment of a guiding device for guiding an impact head and of a homogenizing valve comprising said guiding device, as illustrated in the accompanying drawings in which:

FIGS. 1 to 3 illustrate a guiding device for guiding an impact head, according to a first embodiment of the invention, in three different exploded views;

FIG. 4 illustrates a homogenizing valve comprising the guiding device of FIGS. 1-3, in a longitudinal cross-sectional view;

FIG. 5 is an enlarged view of the homogenizing valve of FIG. 4 in the area of the guiding device;

FIGS. 6 and 7 illustrate a guiding device for guiding an impact head, according to a second embodiment of the invention, in two different exploded views;

FIG. 8 illustrates a cross-sectional view of the guiding device according to the second embodiment, inserted in a homogenizing valve.

### DETAILED DESCRIPTION OF PREFERRED EMBODIMENTS OF THE INVENTION

With reference to the figures, reference numeral 1 denotes a guiding device for guiding an impact head 100 of a homogenizing valve 200.

In this context, an impact head 100 is also called striking head.

The guiding device 1 comprises a solid body 2 having a cylindrical symmetry and having an internal cavity 3 passing through the solid body 2.

The internal cavity 3 develops according to an axis of symmetry A-A of the solid body 2.

In particular, the internal cavity 3 is coaxial with the solid body 2.

Preferably, the solid body 2 is made of a single piece.

For example, the solid body 2 is made of steel.

Alternatively, the solid body 2 is made of a metal material.

The guiding device 1 further comprises a sleeve 9 fitted within the internal cavity 3 of the solid body 2 for receiving the impact head 100.

The sleeve 9 is made by a plastic material.

In particular, the sleeve 9 is made by PTFE.

The solid body 2 has a plurality of passages 4 that are obtained for allowing the passage of a fluid.

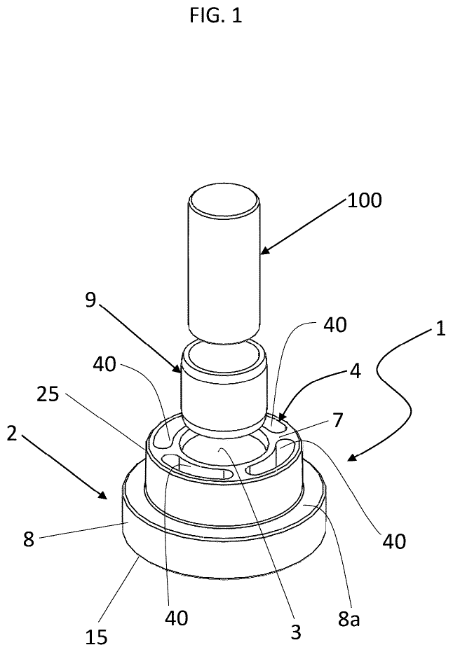

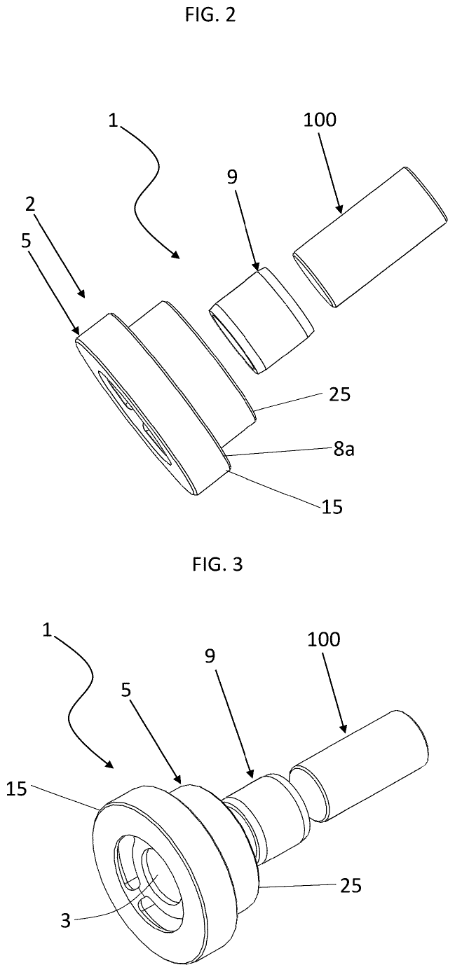

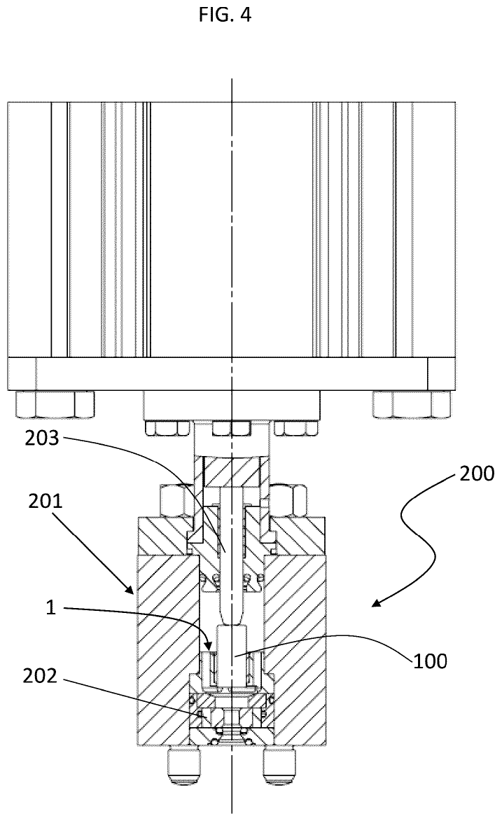

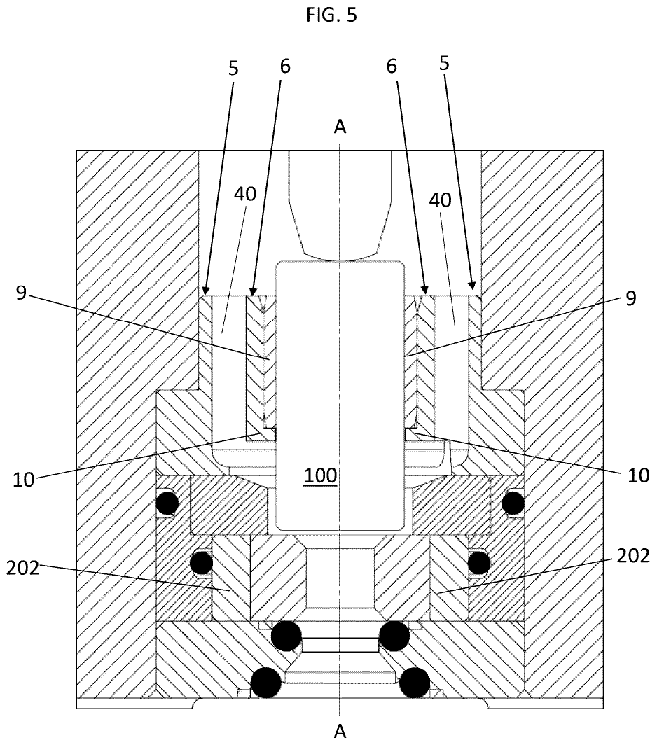

According to a first embodiment of the invention, illustrated in FIGS. 1-3, the solid body 2 comprises a case 5 and a core 6 located inside the case 5. The case 5 and the core 6 are integrally connected. Preferably, the case 5 and the core 6 are connected by a plurality of connecting elements 7.

The internal cavity 3 is delimited by the core 6.

In the first embodiment, the passages 4 are through-holes 40 obtained between the case 5 and the core 6. The through-holes 40 are separated by the connecting elements 7 that connect the case 5 to the core 6.

The core 6 has a substantially hollow cylindrical shape.

In particular, the core 6 has an annular protrusion 10 at one end so as to retain the sleeve 9.

The annular protrusion 10 projects inward towards the hollow of the core 6. In other words, the annular protrusion 10 projects towards the internal cavity 3.

Preferably, the through-holes 40 are arranged around the core 6.

In particular, each through-hole 40 has an arcuated development.

For example, the through-holes 40 are four and are distributed circumferentially so as to be arranged around the core 6.

Preferably, the through-holes 40 have all the same dimensions and shape and are equally spaced.

In the first embodiment, the case 5 comprises a first portion 15 having a first external diameter and a second portion 25 having a second external diameter that is lower than the first external diameter.

Preferably, the first portion 15 and the second portion 25 have a substantially hollow cylindrical shape.

The second portion 25 is integral and coaxial with the first portion 15 according to the axis of symmetry A-A.

According to an aspect of the invention, the second portion 25 originates from the first portion 15.

In particular, the solid body 2 comprises an external surface 8 having an annular step 8a that externally connects the first portion 15 to the second portion 25.

In particular, the annular step 8a is defined by narrowing of the diameter passing from the first portion 15 to the second portion 25.

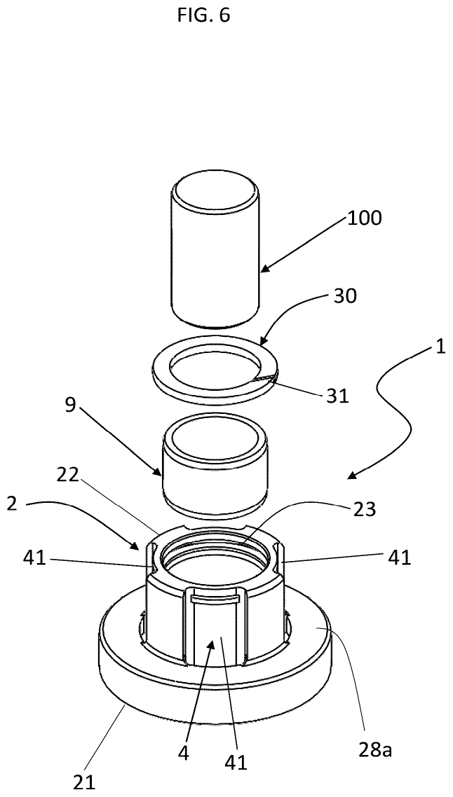

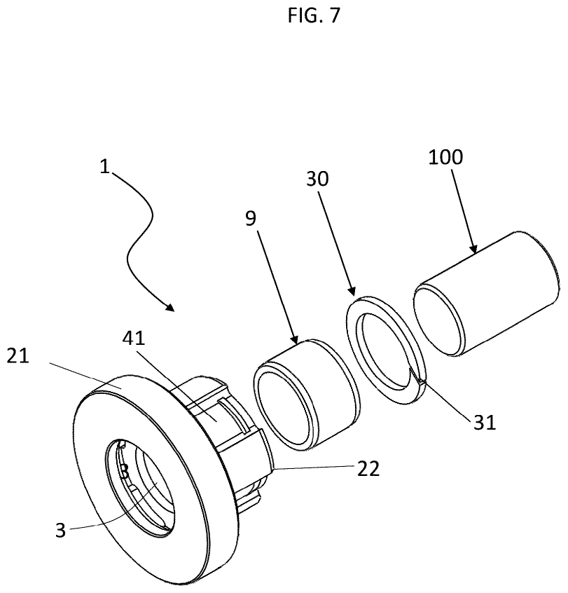

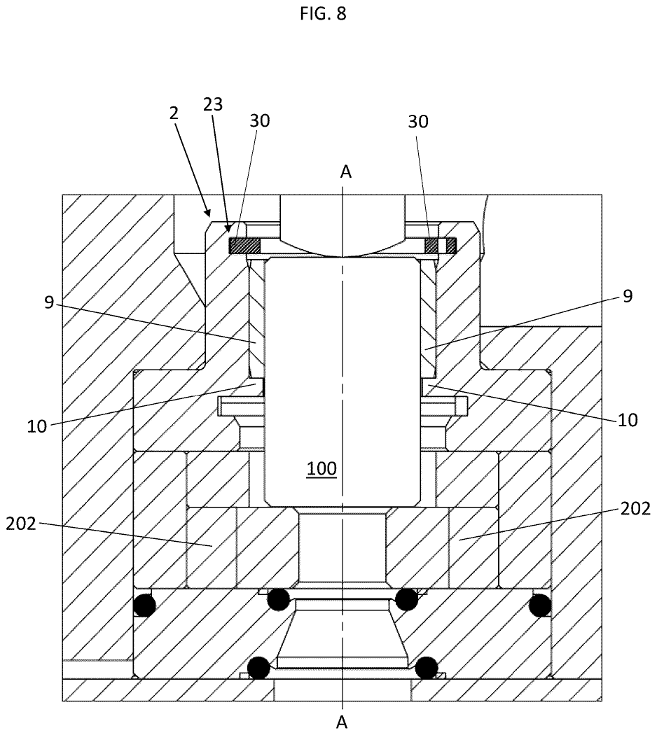

According to a second embodiment of the invention, illustrated in FIGS. 6-7, the passages 4 are grooves 41 obtained in the solid body 2.

In this context, the grooves 41 are blind apertures.

In the second embodiment, the solid body 2 comprises a first element 21 and a second element 22 that are integrally connected and coaxial.

Preferably, the first element 21 and the second element 22 have a substantially hollow cylindrical shape.

They are coaxial according to the axis of symmetry A-A of the solid body 2. In particular, the second element 22 originates from the first element 21.

The first element 21 has an external diameter that is higher than the external diameter of the second element 22.

Preferably, the first element 21 and the second element 22 are connected by an annular step 28a that is defined by narrowing of the diameter passing from the first element 21 to the second element 22.

In the second embodiment, the grooves 41 are obtained in the second element 22 of the solid body 2.

In particular, the grooves 41 are obtained on an external lateral surface of the second element 22.

Preferably, the grooves 41 are equally spaced according to a circumferential development of the second element 22.

For example, the grooves 41 are four.

In the second embodiment, the solid body 2 has an internal annular protrusion 10 so as to retain the sleeve 9 at one end.

The annular protrusion 10 of the solid body 2 projects inward towards the cavity 3.

Preferably, the guiding device 1 further comprises a stop element 30 operatively active on another end of the sleeve 9 that is opposite to the end close to the protrusion 10.

The stop element 30 is used to maintain the sleeve 9 fitted inside the cavity 3 of the solid body 2.

The stop element 30 is inserted inside an internal annular groove 23 obtained in the second element 22.

Preferably, the stop element 30 is a seeger.

The seeger 30 is an annular stop element with a cut 31, that is preferably made of an elastic material. For example, the seeger 30 is made of plastic, in particular PEEK.

The seeger 30 may be fitted easily inside the internal annular groove 23 due to its elasticity and the presence of the cut 31. Number 200 identifies a homogenizing valve comprising a valve body 201 defining a through-hole having axial development with respect to the valve body 201.

The homogenizing valve 200 comprises a shaft 203 housed in the through-hole defined by the valve body 201.

The homogenizing valve 200 has a gap wherein a fluid to be homogenized is accelerated.

The gap is defined by a passage head 202 that is integrally connected to the valve body 201 and an impact head 100 that is integrally connected to the shaft 203.

The homogenizing valve 200 has an inlet for a fluid at high pressure and an outlet for homogenized fluid at low pressure.

The homogenizing valve 200 comprises a guiding device 1 according to the proposed invention.

According to one aspect of the invention, the solid body 2 of the guiding device 1 has a recess for supporting the valve body 201.

In particular, the valve body 201 urges on the annular step 8a, 28a of the solid body 2.

The impact head 100 is received by the sleeve 9 of the guiding device 1.

The impact head 100 is actuated by a shaft 203 that is integrally connected to the impact head 100.

In particular, the shaft 203 is located in an upper part of the homogenizing valve 200.

Under the pushing action of the shaft 203, the impact head 100 is moved downwards, that means towards the gap that receives the fluid from the inlet and delivers it to the outlet.

The impact head 100, being fitted inside the sleeve 9 is guided towards the passage head 202.

The guiding device 1 allows the passage of the fluid thanks to the passages 4, that are the through-holes 40 or the grooves 41.

According to an aspect of the invention, the impact head 100 is made of one of the following materials: tungsten carbide, ceramic, boron nitride, silicon carbide, silicon nitride.

The characteristics of the guiding device for guiding an impact head and of a homogenizing valve comprising said guiding device according to the present invention emerge clearly from the above description, as do the advantages.

In particular, the guiding device is designed to guide the impact head by embracing it, thus reducing tolerances and misalignments.

In addition, the impact head may be actuated in a more accurate and reliable way since the guiding device acts on the impact head close to the working area, i.e., the gap of the homogenizing valve. Providing a guiding device close to the working area is feasible thanks to the through-holes or grooves that allow the passage of the fluid.

With the claimed invention, the lifetime of the impact head is increased with respect to the known solutions.

Furthermore, since the impact head is guided by the guiding device, it can be manufactured in material such as ceramic, boron nitride, silicon carbide, which are less hard than tungsten carbide.

1. A guiding device for guiding an impact head of a homogenizing valve, said guiding device comprising:
a solid body having a cylindrical symmetry and having an internal cavity passing through the solid body, said internal cavity developing according to an axis of symmetry the solid body, said solid body having a plurality of passages that are obtained for allowing the passage of a fluid;
a sleeve fitted within the internal cavity of the solid body for receiving the impact head

2. The guiding device according to claim 1, wherein the solid body made of a single piece.

3. The guiding device according to claim 1, wherein the solid body comprises a case and a core that are integrally connected, the internal cavity being delimited by the core.

4. The guiding device according to claim 3, wherein the passages of the plurality of passages are through-holes obtained between the case and the core, said through-holes being separated by connecting elements that connect the core to the case.

5. The guiding device according to claim wherein the core a substantially hollow cylindrical shape.

6. The guiding device according to claim 5, wherein the core an annular protrusion at one end so as to retain said sleeve.

7. The guiding device according to claim 6, wherein the annular protrusion projects inward towards the internal cavity.

8. The guiding device according to claim to 7, where said through-holes are arranged around the core.

9. The guiding device according to claim 8, wherein each of said through-holes has an arcuated development.

10. The guiding device according to claim 1, wherein the passages of said plurality of passages are grooves obtained in the solid body

11. The guiding device according to claim 10, wherein the solid body comprises a first element and a second element that are integrally connected and coaxial, the second element originating from the first element, said grooves being obtained in the second element.

12. The guiding device according to claim 11, wherein said second element has a cylindrical symmetry, said grooves being obtained on an external lateral surface of the second element.

13. The guiding device according to claim 12, further comprising a stop element operatively active on said sleeve for maintaining it fitted within the internal cavity of the solid body the second element having an internal annular groove for receiving said stop element.

14. The guiding device according to claim 13, wherein the stop element is a seeger.

15. A homogenizing valve comprising:
a valve body defining a through-hole having axial development with respect to the valve body;
a shaft housed in said through-hole;
a passage head integrally connected to the valve body;
an impact head integrally connected to the shaft;
a gap defined by the passage head and the impact;
a guiding device according to claim 1, said impact head being received by the sleeve of said guiding device.

16. The homogenizing valve according to claim 15, wherein said impact head is made of one of the following materials: tungsten carbide, ceramic, boron nitride, silicon carbide, silicon nitride.
